(19) United States
(12) Patent Application Publication
(10) Pub. No.: US 2024/0383411 A1
(43) Pub. Date: Nov. 21, 2024

(54) VEHICLE ACCESSORY CARRIER SYSTEM

(71) Applicant: Partee Group LLC., Lake in the Hills, IL (US)

(72) Inventors: Jonathan Smith, Lake in The Hills, IL (US); Brian Schwartz, Algonquin, IL (US); Kevin Schwartz, Crystal Lake, IL (US); Gilberto Cavada, Wauconda, IL (US); Vladyslav Burlaka, Lviv (UA); Mykola Pochyhaylo, Lviv (UA); Reed Felton, Wauwatosa, WI (US)

(21) Appl. No.: 18/664,585

(22) Filed: May 15, 2024

Related U.S. Application Data
(60) Provisional application No. 63/467,946, filed on May 20, 2023.

(51) Int. Cl. B60R 11/00

(52) U.S. Cl. CPC B60R 11/00; B60R 2011/0026; B60R 2011/0059

(57) ABSTRACT

A vehicle accessory carrier system for mounting to opposing upright members of a windshield frame of the vehicle includes a mounting bar extending between and operably connected to the opposing upright members, mounting clips for mounting the mounting bar to the opposing upright members, the mounting clips operably connecting the mounting bar to the opposing upright members, and one or more storage containers removably mounted to the mounting bar. A fastening system removably attaches the storage containers to the mounting bar.

### CROSS-REFERENCE TO RELATED APPLICATION DATA

This application claims the benefit of and priority to Provisional U.S. Patent Application Ser. No. 63/467,946, filed May 20, 2023, titled Utility Basket for Golf Cart, the disclosure of which is incorporated herein in its entirety.

### BACKGROUND

The present disclosure is directed to a vehicle accessory carrier or caddy, and more particularly, to a carrier or caddy that mounts to a frame, such as a windshield frame of, for example, a golf cart.

Golfers and other golf cart users may carry beverages, such as water, wine, soda pop and the like when, for example, playing a round of golf, or driving around a golf cart community. It may, however, be difficult to store and maintain such beverages at a desired temperature, and within reach while operating the cart or waiting for play. Dashboard cup holders are known, however, known cup holders only hold cups, cans, bottles, and the like of a given size, and do not maintain the temperature of the stored drink.

Given the limited space in the passenger compartment of golf carts, often used hard-sided coolers must be secured to the back of such carts. This location is inconvenient in that it requires that an individual exit the cart, walk around to the rear of the cart and choose the desired drink.

Moreover, most hard sided coolers have open, unstructured interiors. While this may be advantageous in that more items can be stored in the cooler, it does not adequately secure what is stored therein. This can be particularly troublesome when the cooler is not full and the items in the cooler are unsecured and can tip or break.

Soft-sided coolers are also known, but they too are often located at the rear of the cart and it may be difficult to retrieve items form such coolers.

Accordingly, there is a need for an accessory carrier system that is readily reachable from the interior of the cart or other vehicle. Desirably, such a carrier system is readily mounted at an easily accessible location in the golf cart or vehicle. More desirably, such a carrier system can be configured as a storage caddy and can be used to store beverages such as water, wine, soda pop and the like and maintain the temperature of stored beverages. More desirably still, such a storage caddy system can securely store beverages in a manner that eliminates or reduces the opportunity for such beverages to tip and/or fall over when in use.

### BRIEF SUMMARY

In an aspect, a vehicle accessory carrier system is disclosed. The system mounts to opposing upright members of a windshield frame of the vehicle, such as a golf cart. The system includes a mounting bar extending between and operably connected to the opposing upright members and mounting clips for mounting the mounting bar to the opposing upright members. The mounting clips operably connect the mounting bar to the opposing upright members.

One or more storage containers are removably mounted to the mounting bar by a fastening system. In one aspect, the fastening system includes first and second mating engaging elements. The engaging elements removably attach the storage containers to the mounting bar. The first engaging element is affixed to the mounting bar and the second engaging element is mounted to the storage container. Other fastening systems include, for example, hook and loop fasteners such as VELCRO® fasteners, mechanical key/keyway fasteners and the like. Other fastening systems will be recognized by those skilled in the art.

In embodiments, the system further includes side rails mounted to the opposing upright members such that the mounting clips are mounted to side rails. The side rails are configured to vary a mounting height of the mounting bar.

The first and second engaging elements are interlocking elements. In an embodiment, the first engaging element can include a V-shaped receiving element and the second engaging element can include a V-shaped insert element. The insert element is configured for receipt in the receiving element. In embodiments, the receiving element has a base having upper and lower flanges to secure the receiving element to the mounting bar. The receiving element can have a pair of opposing V legs extending outwardly from the base, the V legs spaced from each other by a gap. The V legs have respective transverse portions extending from the base and inwardly extending portions at ends of the transverse portions. The inwardly extending portions define a receiving space between the inwardly extending portions and the base.

In an embodiment, the V legs define a reduced dimension in a downward direction of the legs. Gussets can be formed on outer surfaces of the V legs between the V legs and the base.

The insert element can include a front, a rear wall, and an interconnecting wall. In such an embodiment, slots are defined between the front wall, the rear wall, and the interconnecting wall.

The one or more storage containers each include contiguous upstanding front, rear and side walls, and a bottom wall to define an interior. The bottom wall is joined to the upstanding walls front, rear and side walls, and further includes a top wall releasably joined to the upstanding front and side walls.

The top wall is joined to the upstanding front and side walls by a closure, and is affixed to the rear wall such that the closure extends along the front and side walls. The closure can be, for example, a zipper. The one or more containers can further include a securing member, such as a strap to, for example, secure a cooling pack therein.

In an aspect, a vehicle accessory carrier system for mounting to opposing upright members of a windshield frame of the vehicle includes a mounting bar extending between and operably connected to the opposing upright members, mounting clips for mounting the mounting bar to the opposing upright members, the mounting clips operably connecting the mounting bar to the opposing upright members and one or more storage containers removably mounted to the mounting bar.

First and second mating engaging elements removably attach the storage containers to the mounting bar. The first engaging element is affixed to the mounting bar and the second engaging element is mounted to the storage container. Alternatively, a carrier, such as a wire basket can be mounted to the mounting bar to receive and hold/support a container or other items for storage.

In embodiments, the first engaging element includes a V-shaped receiving element and the second engaging element includes a V-shaped insert element The insert element is received in the receiving element. In embodiments, the receiving element has a pair of opposing legs extending outwardly from the base, which legs are spaced from each other by a gap. The legs have respective transverse portions extending from the base and inwardly extending portions at ends of the transverse portions. The inwardly extending portions defining a receiving space between the inwardly extending portions and the base. The legs define a reduced dimension in a downward direction of the legs.

The insert element has a front wall, a rear wall, and an interconnecting wall, and defines slots between the front wall, the rear wall, and the interconnecting wall. The insert element is positioned in the receiving element with the receiving element legs' inwardly extending portions positioned between the front walls and the rear walls of the insert portion and the interconnecting wall positioned in the receiving element gap.

In embodiments, the storage containers are coolers and each includes contiguous upstanding front, rear and side walls, and a bottom wall to define an interior. The bottom wall is joined to the upstanding walls front, rear and side walls, and the storage container further includes a top wall releasably joined to the upstanding front and side walls. The top wall is joined to the upstanding front and side walls by a zipper.

The coolers further include a securing member on the interior. The securing member can be, for example, a strap for securing a cooling pack therein.

The foregoing general description and the following detailed description are examples only and are not restrictive of the present disclosure.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIG. 1 illustrates an embodiment of a vehicle accessory carrier system or caddy system in accordance with the present disclosure;

FIG. 2 is a view of an embodiment of the caddy system showing a storage container removed from the mounting bar, and showing the engaging members in an exploded view;

FIG. 3 illustrates an embodiment of the caddy system with a bottle extending from one of the storage containers;

FIG. 4 is a top view of an embodiment of a storage container with a portion of the top open;

FIG. 5 is a view of an embodiment of a storage container partially broken away to illustrate one way in which a cooler pack is secured in the container;

FIG. 6 is a view of an embodiment of a storage container partially broken away to illustrate another way in which a cooler pack is secured in the container;

FIG. 7 is a rear view of an embodiment of the storage container; and

FIG. 8 is a perspective view of an embodiment of the caddy system shown partially broken away to illustrate the engaging members securing the container to the mounting bar.

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated.

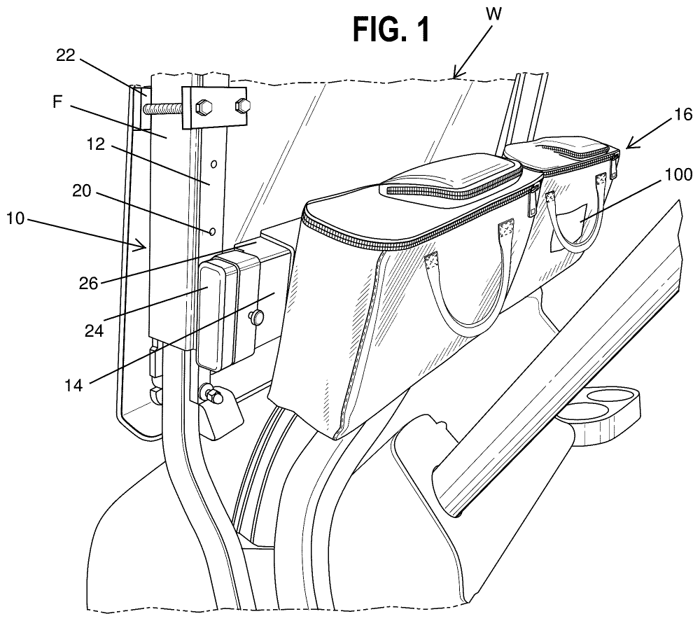

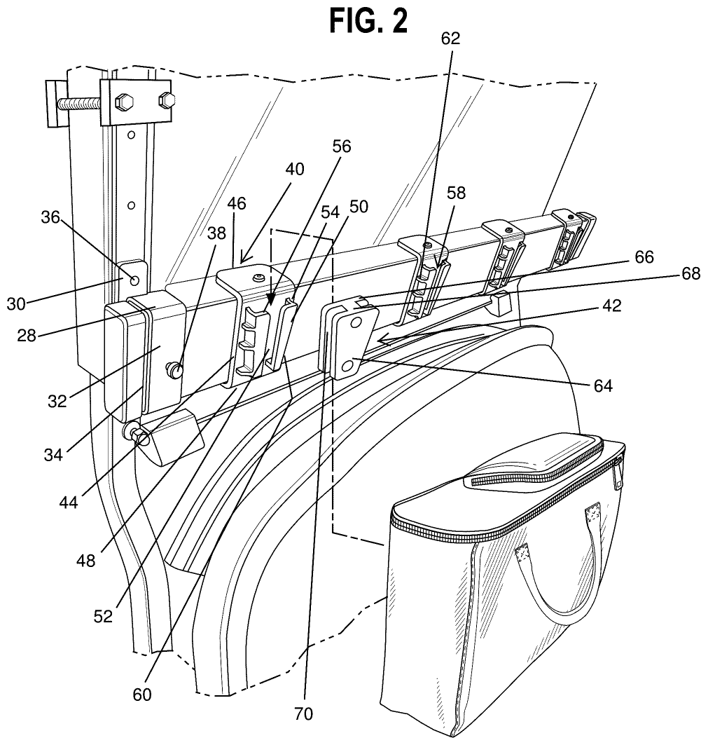

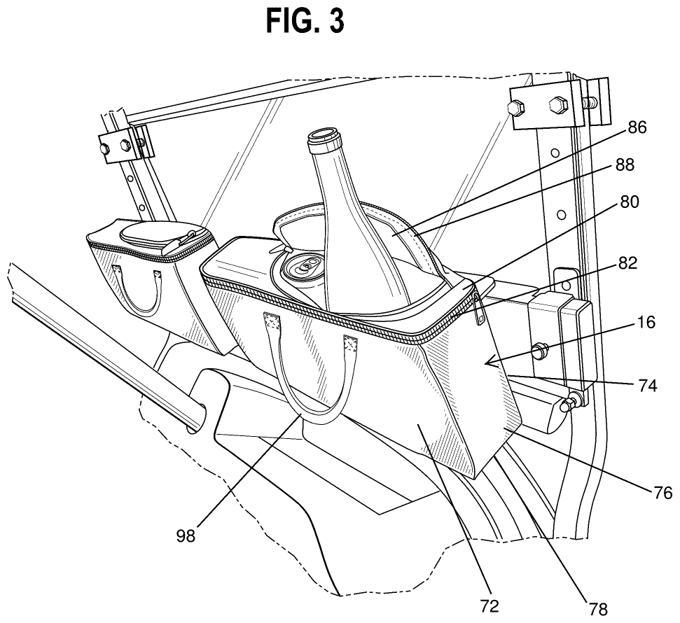

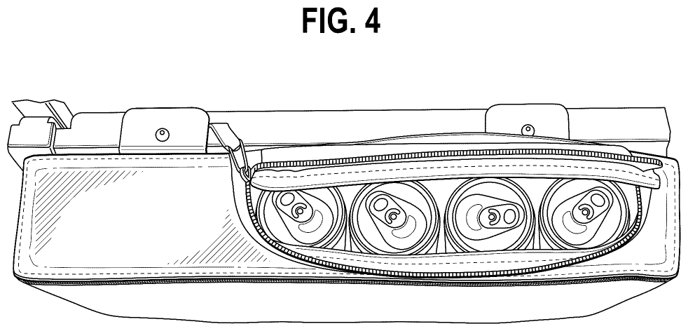

Referring now to the figures and in particular to FIGS. 1 and 2 there is shown an embodiment of a vehicle accessory carrier or caddy system 10. The illustrated caddy system 10 can be mounted to, for example, the frame F of a golf cart windshield or windscreen W. The system 10 includes generally a pair of side rails 12, a mounting bar 14, one or more storage containers 16, and a fastening system 18 to removably attach the storage containers 16 to the mounting bar 14. In present system, the storage containers 16 are coolers for storing, for example, cans, bottles, cups, and the like, but it will be appreciated that the containers 16 can be used to storage man different items.

The side rails 14 extend along the windshield frame F for mounting the caddy system 10 to the golf cart. The side rails extend 14 vertically along the windshield frame F and can include a series of holes or openings 20 as will be discussed in more detail below. In an embodiment, the side rails 12 are mounted to the windshield frame F by fasteners such as bolts, by clamps, as indicated at 22 or the like.

The mounting bar 14 extends laterally or horizontally between the windshield frame F uprights and the side rails 12. The mounting bar 14 can be, for example, an extrusion, such as an extruded aluminum bar. The mounting bar can have a cross-sectional shape, such as a “C” shape or can have internal ribs or the like to impart strength and structural integrity to the mounting bar 14. The mounting bar 14 can include caps 24 at the respective ends of the bar 14 to close the ends of the bar 14 as needed.

In embodiments, the mounting bar 14 can have rearwardly extending lip or shelf 26 (rearwardly being toward the windshield W) to allow for storing additional items.

The mounting bar 14 is mounted to the side rails 12 and thus the windshield frame F of the vehicle. In an embodiment, mounting elements, such as clips 28 can be mounted to the side rails 12. In an embodiment, the clips 28 can have a flat mounting arm 30 to mount to the side rails 12. In embodiments, the clips 28 have a leg 32 that wraps around the mounting bar 14. The leg 32 can be an upturned leg or a side-turned leg such that the mounting bar 14 sits between the turned portion of the leg 32 and the flat mounting arm 30 of the clips 28. Alternatively, the clips 28 can be configured having an opening 34 (see, for example FIGS. 1 and 2) such that the mounting bar 14 fits into the opening 34 and is secured therein. The clips 28 can include an opening 36 that is aligned with one of the openings 20 in the side rails 12 to position the mounting bar 14 at selected height (i.e., at any of the openings 20 in the side rail 12) to adjust the height at which the mounting bar 14 and thus the containers 16 are mounted relative to the windshield W. In addition, the clips 28 can be configured to accommodate mounting bars 14 fitted to different widths of windshield frames F.

The clips 28 can be mounted to the side rails 12 and the mounting bar 14 to the clips 28 by fasteners 38 such as screws, knurled-head screws/bolts, and the like. It is envisioned that the mounting bar 14 is secured to the inside of the windshield frame F to provide easy access to the containers 16 for those inside of the cart. The lip or shelf 26 can extend to the windshield W for storage of other items.

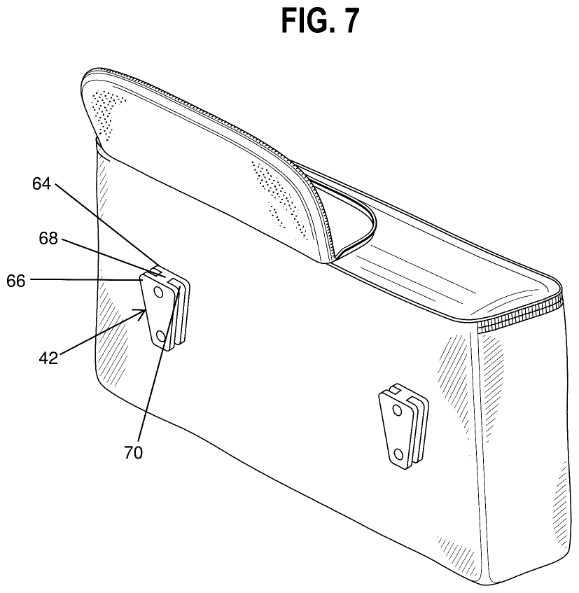

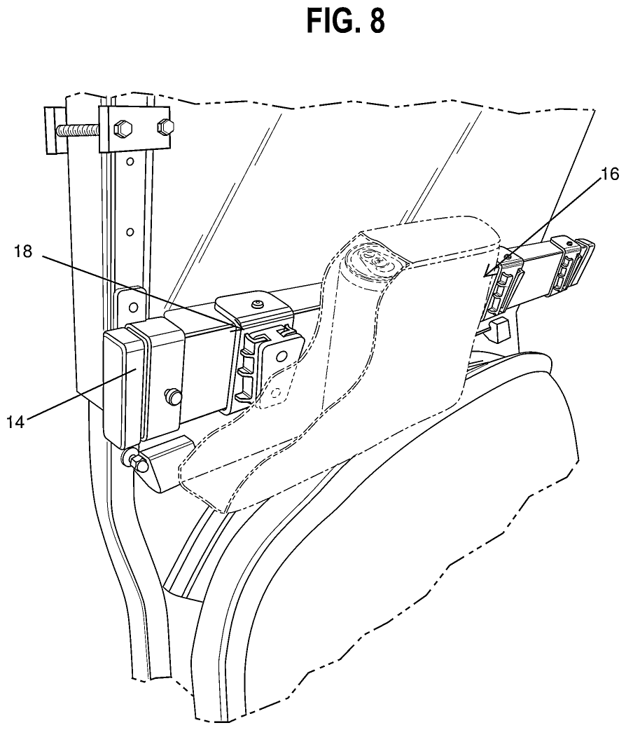

Referring now to FIGS. 2, 7 and 8, the one or more coolers 16 are secured to the mounting bar 14 by a fastening system 18. In embodiments, the fastening system 18 includes interlocking elements, such as mating engaging members 18. In embodiments, the engaging members 18 include mating V-shaped elements 40, 42, one portion 40 of which is secured to the mounting bar 14 and another portion 42 of which is secured to the cooler 16. In a present embodiment, a V-shaped receiving element 40 is mounted to the mounting bar 15 and a mating V-shaped insert element 42 is mounted to the cooler 16. It will be appreciated that the elements 40, 42 can be reversed such that the V-shaped receiving element 40 is mounted to the cooler 16 and a mating V-shaped insert element 42 is mounted to the mounting bar 14. In such a reversed configuration, the receiving and insert elements 40, 42 would be inverted, that is, upside down, with the larger, open end of the receiving element 40 V oriented downwardly.

The receiving element 40 has a base 44 having upper and lower flanges 46, 48 to secure the element 40 to the mounting bar 14 and a pair of opposing V legs 50 extending outwardly from the base 44. The legs 50 are spaced from each other by a gap 52. The legs 50 have respective transverse portions 54 extending from the base 44 and inwardly extending portions 56 at ends of the transverse portions 54. The inwardly extending portions 56 define a receiving space 58 between the inwardly extending portions 56 and the base 44. The V shape of the legs 50 defines an inward taper, as indicated at 60, in a downward direction of the legs 50. Gussets 62 can be formed on outer surfaces of the legs 50 between the legs 50 and the base 44 to provide additional strength, reinforcement, and structural integrity to the legs 50.

The receiving elements 40 can be mounted to the mounting bar 14 using fasteners such as screws, knurled-head screws/bolts, and the like. The receiving elements 40 can be mounted to the mounting bar 14 anywhere along the length of the mounting bar 14 to accommodate coolers 16 of different lengths or coolers having different insert element 42 locations.

The V shaped insert element 42 slides into and secures in the receiving element 40. The insert portion 42 includes front and rear walls 64, 66 and an interconnecting or bridge wall 68. Slots 70 are defined between the front and rear walls 64, 66 and the bridge wall 68. The rear wall 66 is positioned on and secured to a rear wall of the cooler 16. The insert element 42 is positioned in the receiving element 40 such that the receiving element legs' inwardly extending portions 56 fit between the front and rear walls 64, 66 of the insert portion 42, and the bridge or interconnecting wall 68 fits into the gap 52 between the legs 50 of the receiving element 40.

Other fastening systems include, for example, a hook and loop fastening system such as a VELCRO® fastening system, magnetic fasteners, a mechanical key/keyway fastening system and the like. Such other fastening systems will be recognized by those skilled in the art and are within the scope and spirit of the present disclosure.

Referring now to the various figures, as illustrated, the storage containers 16 are coolers. The coolers 16 each include contiguous upstanding front, rear and side walls 72, 74, 76, respectively. A bottom wall 78 is joined to the upstanding walls 72-76 and a top 80 is releasably joined to the upstanding walls 72-76. The top 80 can be joined to the upstanding front and side walls 72, 76 by a closure 82 such as a zipper and affixed to the rear wall 74 such that zipper 82 extends along three sides (the front 72 and two adjacent sides 76) of the cooler 16, and is used to open and close the cooler 16. A portion of the top 80 can include a closable portion or window 86 that can be opened to accommodate containers larger (taller) than the height of the upstanding walls 72-76, such as wine bottles. The window 86 can likewise include a closure 88 such as a zipper, a hook and loop fastener system, a snap closure, or the like. Alternatively, a carrier, such as a wire basket or the like can be mounted to the mounting bar 14 to receive the containers (such as the cooler or coolers 16) or other items for storage.

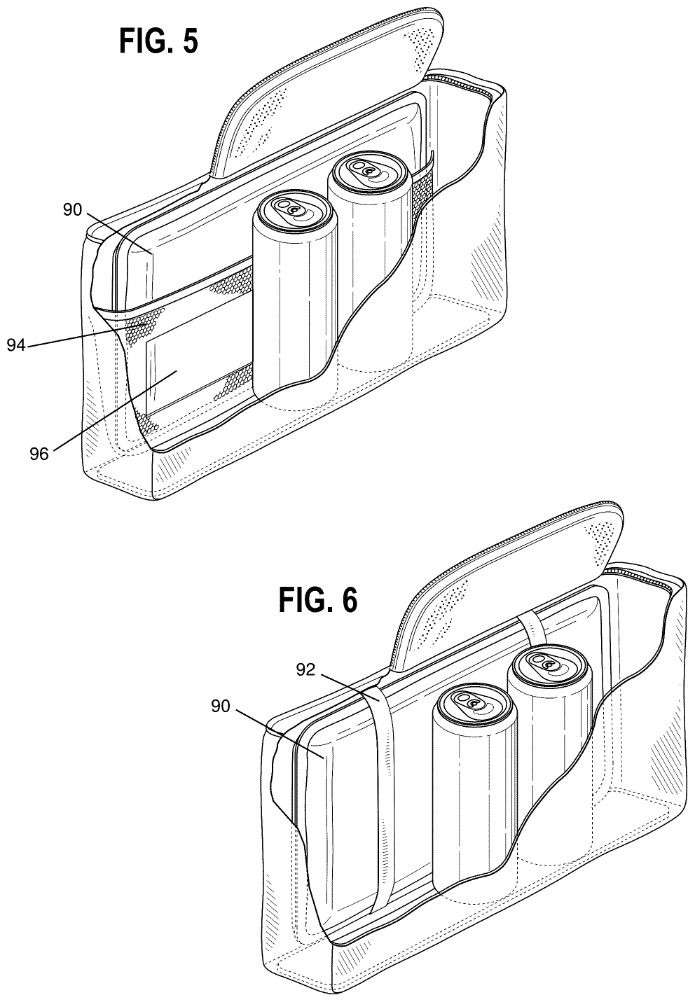

To maintain the cooler 16 contents at a desired temperature, the cooler 16 can include one or more cooling packs 90, such as those illustrated in FIGS. 5 and 6. It is envisioned that the cooling packs 90 will be relatively thin components and are fit into and secured in the cooler 16. In embodiments, the cooling packs 90 are mounted in the coolers 16 so that a surface of a cooling pack 90 is in contact with the beverages stored in the cooler 16. In an embodiment as seen in FIG. 6, the cooling packs 90 are maintained in place by straps 92, such as elastic straps to secure the cooling packs 90 in place. Alternatively, as seen in FIG. 5, the cooler 16 can include an envelope 94 into which the cooling packs are slipped, and the envelope 94 can have an open central window 96. In such arrangements, as noted above, the cooling pack 90 is in contact with the beverages in the cooler 16. The coolers 16 can include carry handles 98, for example, similar to a brief case, for ease of carrying the cooler 16 separate from the mounting system. Other handles, shoulder straps and the like will be recognized by those skilled in the art. The coolers 16 can also include an outside pocket 100 to, for example, hold a cell phone, keys, and the like.

It will be appreciated that the present vehicle accessory carrier system or caddy system 10, provides a secure and efficient way in which to store and carry items when in a golf cart or other similar vehicle. The present caddy system 10 allows the user to keep items, such as drinks cool and securely held while the vehicle is operated. Further, the present caddy system 10 can be used or mounted to most any golf cart or vehicle having an accessible windshield frame F to which the system 10 can be mounted.

The words “a” or “an” are to be taken to include both the singular and the plural. Conversely, any reference to plural items shall, where appropriate, include the singular. The words “first,” “second,” “third,” and the like may be used in the present disclosure to describe various information, such information should not be limited to these words. These words are only used to distinguish one category of information from another. The directional words “top,” “bottom,” up,” “down,” front,” “back,” and the like are used for purposes of illustration and as such, are not limiting. Depending on the context, the word “if” as used herein may be interpreted as “when” or “upon” or “in response to determining.”

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

1. A vehicle accessory carrier system for mounting to opposing upright members of a windshield frame of the vehicle, the system comprising:
a mounting bar extending between and operably connected to the opposing upright members;
mounting clips for mounting the mounting bar to the opposing upright members, the mounting clips operably connecting the mounting bar to the opposing upright members;
one or more storage containers removably mounted to the mounting bar; and
a fastening system for removably attaching the storage containers to the mounting bar.

2. The vehicle accessory carrier system of claim 1, wherein the fastening system includes first and second mating engaging elements for removably attaching the storage containers to the mounting bar, the first engaging element affixed to the mounting bar and the second engaging element mounted to the storage container.

3. The vehicle accessory carrier system of claim 1 further including side rails, the side rails being mounted to the opposing upright members, wherein the mounting clips are mounted to side rails.

4. The vehicle accessory carrier system of claim 3, wherein the side rails are configured to vary a mounting height of the mounting bar.

5. The vehicle accessory carrier system of claim 2, wherein the first engaging element includes a V-shaped receiving element and the second engaging element includes a V-shaped insert element, the insert element being received in the receiving element.

6. The vehicle accessory carrier system of claim 5, wherein the receiving element has a base having upper and lower flanges to secure the receiving element to the mounting bar.

7. The vehicle accessory carrier system of claim 5, wherein the receiving element has a pair of opposing V legs extending outwardly from the base, the V legs spaced from each other by a gap.

8. The vehicle accessory carrier system of claim 7, wherein the V legs have respective transverse portions extending from the base and inwardly extending portions at ends of the transverse portions, the inwardly extending portions defining a receiving space between the inwardly extending portions and the base.

9. The vehicle accessory carrier system of claim 7, wherein the V legs define a reduced dimension in a downward direction of the legs.

10. The vehicle accessory carrier system of claim 7, further including gussets formed on outer surfaces of the V legs between the V legs and the base.

11. The vehicle accessory carrier system of claim 5, wherein the insert element includes a front, a rear wall, and an interconnecting wall.

12. The vehicle accessory carrier system of claim 11, wherein slots are defined between the front wall, the rear wall, and the interconnecting wall.

13. The vehicle accessory carrier system of claim 1, wherein the one or more storage containers each include contiguous upstanding front, rear and side walls, and a bottom wall to define an interior, wherein the bottom wall is joined to the upstanding walls front, rear and side walls, and a further including a top wall releasably joined to the upstanding front and side walls.

14. The vehicle accessory carrier system of claim 13, wherein the top wall is joined to the upstanding front and side walls by a closure, and is affixed to the rear wall such that the closure extends along the front and side walls.

15. The vehicle accessory carrier system of claim 14, wherein the closure is a zipper.

16. The vehicle accessory carrier system of claim 13, further including a securing member on the interior.

17. The vehicle accessory carrier system of claim 16, wherein the securing member is a strap for securing a cooling pack therein.

18. A vehicle accessory carrier system for mounting to opposing upright members of a windshield frame of the vehicle, the system comprising:
a mounting bar extending between and operably connected to the opposing upright members;
mounting clips for mounting the mounting bar to the opposing upright members, the mounting clips operably connecting the mounting bar to the opposing upright members;
one or more storage containers removably mounted to the mounting bar; and
first and second mating engaging elements for removably attaching the storage containers to the mounting bar, the first engaging element affixed to the mounting bar and the second engaging element mounted to the storage container,
the first engaging element including a V-shaped receiving element and the second engaging element includes a V-shaped insert element, the insert element being received in the receiving element, wherein the receiving element has a pair of opposing legs extending outwardly from the base, the legs spaced from each other by a gap, the legs having respective transverse portions extending from the base and inwardly extending portions at ends of the transverse portions, the inwardly extending portions defining a receiving space between the inwardly extending portions and the base, the legs defining a reduced dimension in a downward direction of the legs,
the insert element having a front wall, a rear wall, and an interconnecting wall, and defining slots between the front wall, the rear wall, and the interconnecting wall,
wherein the insert element is positioned in the receiving element with the receiving element legs' inwardly extending portions positioned between the front walls and the rear walls of the insert portion and the interconnecting wall positioned in the receiving element gap.

19. The vehicle accessory carrier system of claim 18, wherein the one or more storage containers are coolers and each include contiguous upstanding front, rear and side walls, and a bottom wall to define an interior, wherein the bottom wall is joined to the upstanding walls front, rear and side walls, and a further including a top wall releasably joined to the upstanding front and side walls, and wherein the top wall is joined to the upstanding front and side walls by a zipper.

20. The vehicle accessory carrier system of claim 19, further including a securing member on the interior.

21. The vehicle accessory carrier system of claim 20, wherein the securing member is a strap for securing a cooling pack therein.
